(19) United States
(12) Patent Application Publication
(10) Pub. No.: US 2023/0073060 A1
(43) Pub. Date: Mar. 9, 2023

(54) TUNABLE LASER EMITTER WITH 1D GRATING SCANNER FOR 2D SCANNING

(71) Applicant: BEIJING VOYAGER TECHNOLOGY CO., LTD., Beijing (CN)

(72) Inventors: Youmin Wang, Berkeley, CA (US); Yue Lu, Mountain View, CA (US)

(73) Assignee: BEIJING VOYAGER TECHNOLOGY CO., LTD., Beijing (CN)

(21) Appl. No.: 17/468,464

(22) Filed: Sep. 7, 2021

(51) Int. Cl. G01S 7/481; G01S 17/34

(52) U.S. Cl. CPC G01S 7/4814; G01S 7/4817; G01S 17/34; G01S 17/931

(57) ABSTRACT

Embodiments of the disclosure provide an optical sensing system for two-dimensional (2D) environmental sensing, an optical sensing method for the optical sensing system, and a transmitter. The optical sensing system includes a tunable laser source configured to emit optical signals with varying wavelengths. The optical sensing system further includes a one-dimensional (1D) grating scanner configured to rotate around a rotational axis to scan the optical signals with the varying wavelengths in a first dimension towards an environment surrounding the optical sensing system. The 1D grating scanner includes a grating structure configured to scan the optical signals with the varying wavelengths along different directions in a second dimension towards the environment at each rotation angle. The optical sensing system additionally includes a receiver configured to receive at least a portion of the optical signals with the varying wavelengths reflected from the environment.

### TECHNICAL FIELD

The disclosure relates to a light detection and ranging (LiDAR) system, and more particularly to, a scanning LiDAR system including a tunable laser emitter with a one-dimensional (1D) grating scanner for two-dimensional (2D) scanning.

### BACKGROUND

In a scanning LiDAR system, to realize 2D scanning typically requires a pair of cascaded scanning elements. For example, in a micro-electro-mechanical system (MEMS) and galvo-based scanning system, a MEMS-actuated scanner scans a fast axis and a galvo-controlled scanner scans a slow axis. However, with more moving parts introduced into a system, it adds a risk of reliability to the system. Another approach to 2D scanning is to include an integrated 2D scanner. For example, a 2D MEMS mirror can achieve a scanning of both horizontal and vertical axes at the same time. However, due to the more complex mechanical design required for such a high-speed scanning system, a 2D MEMS-based scanner also suffers from compromised performance and reliability.

Embodiments of the disclosure address the above problems by providing a scanning LiDAR system containing a tunable laser emitter with a 1D grating scanner for 2D scanning.

### SUMMARY

Embodiments of the disclosure provide an optical sensing system for 2D environmental sensing. The optical sensing system includes a tunable laser source configured to emit optical signals with varying wavelengths. The optical sensing system further includes a one-dimensional (1D) grating scanner configured to rotate around a rotational axis to scan the optical signals with the varying wavelengths in a first dimension towards an environment surrounding the optical sensing system. The 1D grating scanner includes a grating structure configured to scan the optical signals with the varying wavelengths along different directions in a second dimension towards the environment at each rotation angle. The optical sensing system additionally includes a receiver configured to receive at least a portion of the optical signals with the varying wavelengths reflected from the environment.

Embodiments of the disclosure further provide an optical sensing method for an optical sensing system. The optical sensing method includes emitting, by a tunable laser source of the optical sensing system, optical signals with varying wavelengths. The method further includes directing, by a 1D grating scanner of the optical sensing system, the optical signals with the varying wavelengths towards an environment surrounding the optical sensing system. The 1D grating scanner is configured to rotate around a rotational axis to scan the optical signals with the varying wavelengths in a first dimension towards the environment. The 1D grating scanner includes a grating structure configured to scan the optical signals with the varying wavelengths along different directions in a second dimension towards the environment at each rotation angle. The method further includes receiving, by a receiver of the optical sensing system, at least a portion of the optical signals with the varying wavelengths reflected from the environment.

Embodiments of the disclosure further provide a transmitter for an optical sensing system. The transmitter includes a tunable laser source configured to emit optical signals with varying wavelengths. The transmitter further includes one or more optics configured to collimate the optical signals with the varying wavelengths. The transmitter additionally includes a one-dimensional (1D) grating scanner configured to rotate around a rotational axis to scan the optical signals with the varying wavelengths in a first dimension towards an environment surrounding the optical sensing system. The 1D grating scanner includes a grating structure configured to scan the optical signals with the varying wavelengths along different directions in a second dimension towards the environment at each rotation angle.

It is to be understood that both the foregoing general description and the following detailed description are exemplary and explanatory only and are not restrictive of the disclosure, as claimed.

### BRIEF DESCRIPTION OF THE DRAWINGS

FIG. 1 illustrates a schematic diagram of an exemplary vehicle equipped with a LiDAR system including a tunable laser emitter with a 1D grating scanner for 2D scanning, according to embodiments of the disclosure.

FIG. 2 illustrates a block diagram of an exemplary LiDAR system including a tunable laser emitter with a 1D grating scanner for 2D scanning, according to embodiments of the disclosure.

FIG. 3 illustrates a block diagram of an exemplary operation of a LiDAR system including a tunable laser emitter with a 1D grating scanner for 2D scanning, according to embodiments of the disclosure.

FIG. 4 illustrates a schematic diagram of exemplary wavelength changing patterns of laser beams emitted by a tunable laser emitter, according to embodiments of the disclosure.

FIG. 5 illustrates a schematic diagram of an exemplary operation of a 1D grating scanner for 2D scanning, according to embodiments of the disclosure.

FIGS. 6A-6B illustrate a schematic diagram of grating diffraction of laser beams with different wavelengths, according to embodiments of the disclosure.

FIG. 7 illustrates a schematic diagram of exemplary 2D scanning patterns generated by a LiDAR system containing a tunable laser emitter and a 1D grating scanner, according to embodiments of the disclosure.

FIG. 8 is a flow chart of an exemplary optical sensing method of a LiDAR system including a tunable laser emitter with a 1D grating scanner for 2D scanning, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the disclosure provide an exemplary scanning LiDAR system containing a tunable laser emitter with a 1D grating scanner for 2D scanning. In the disclosed LiDAR system, a first dimensional scanning may be achieved through the rotation of a 1D grating scanner included in the system. For instance, the 1D grating scanner may direct the laser beams towards different directions along one dimension when the 1D grating scanner rotates along a rotational axis of the scanner, thereby achieving the first dimensional scanning. This first dimension may be perpendicular to the rotational axis of the 1D grating scanner.

A second dimensional scanning may be achieved through a grating diffraction of laser beams with different wavelengths by the 1D grating scanner. The second dimension may be perpendicular to the first dimension. To achieve the second dimensional scanning, the 1D grating scanner may include a grating structure, e.g., a plurality of parallel grating slits, which may diffract incoming laser beams incident on the surface of the 1D grating scanner at a fixed angle. In some embodiments, the −1^{st} order diffraction angle of the laser beams diffracted by the grating structure may correspond to the wavelength of incident laser beams. Accordingly, when the wavelength of the laser beams incident on the grating structure decreases or increases, the −1^{st} order diffraction angle of the diffracted laser beams may also decrease or increase along the second dimension, thereby accomplishing the second dimensional scanning of the 2D scanning.

As can be seen, in the disclosed 2D scanning LiDAR system, fewer moving parts are required when compared to a MEMS and galvo-based 2D scanning LiDAR system. Meanwhile, when compared to a 2D MEMS scanner, a less complex mechanical design is required in the disclosed 2D scanning LiDAR system, since only a 1D MEMS scanner is used in the disclosed 2D scanning LiDAR system. Accordingly, the disclosed 2D scanning LiDAR system may achieve a 2D scanning with less moving or mechanical parts required when comparing to other existing LiDAR systems, and thus the performance and reliability of the disclosed 2D scanning LiDAR system can be improved when compared to other existing 2D scanning LiDAR systems. The features and advantages described herein are not exhaustive and many additional features and advantages may be apparent to one of ordinary skill in the art in view of the figures and the following descriptions.

The disclosed LiDAR system containing a tunable laser emitter with a 1D grating scanner can be used in many applications, including 2D scanning-related applications. For example, the disclosed LiDAR system can be used in advanced navigation technologies, such as to aid autonomous driving or to generate high-definition maps, in which the optical sensing system can be equipped on a vehicle.

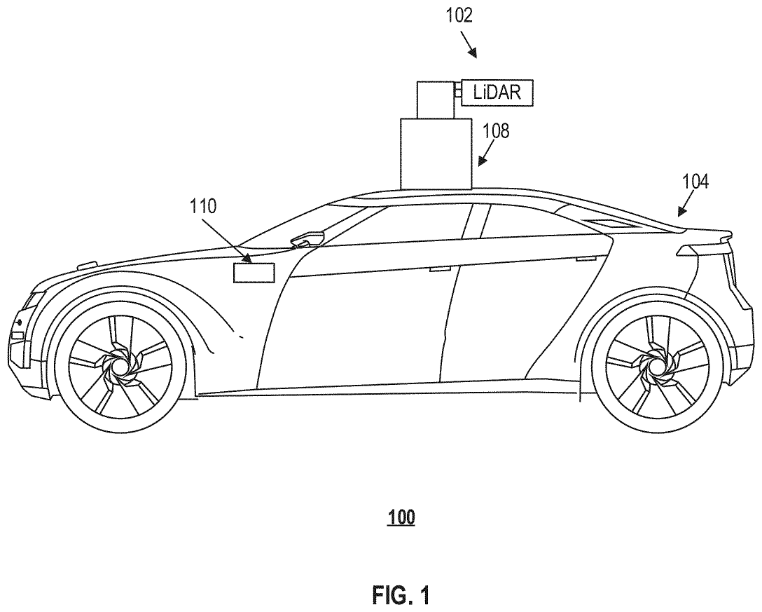

FIG. 1 illustrates a schematic diagram of an exemplary vehicle 100 equipped with an optical sensing system containing a tunable laser emitter with a 1D grating scanner, according to embodiments of the disclosure. Consistent with some embodiments, vehicle 100 may be a survey vehicle configured for acquiring data for constructing a high-definition map or three-dimensional (3D) buildings and city modeling. Vehicle 100 may also be an autonomous driving vehicle.

As illustrated in FIG. 1, vehicle 100 may be equipped with an optical sensing system, e.g., a LiDAR system 102 (also referred to as “LiDAR system 102” hereinafter) mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, the scanning system of LiDAR system 102 may be configured to scan the surrounding environment in a 2D scanning manner. LiDAR system 102 measures distance to a target by illuminating the target with laser beams and measuring the reflected/scattered pulses with a receiver. The laser beams used for LiDAR system 102 may be ultraviolet, visible, or near-infrared, and may be pulsed or continuous wave laser beams. In some embodiments of the present disclosure, LiDAR system 102 may capture point clouds including depth information of the objects in the surrounding environment, which may be used for constructing a high-definition map or 3D buildings and city modeling. As vehicle 100 moves along the trajectory, LiDAR system 102 may continuously capture data including the depth information of the surrounding objects (such as moving vehicles, buildings, road signs, pedestrians, etc.) for map, building, or city modeling construction.

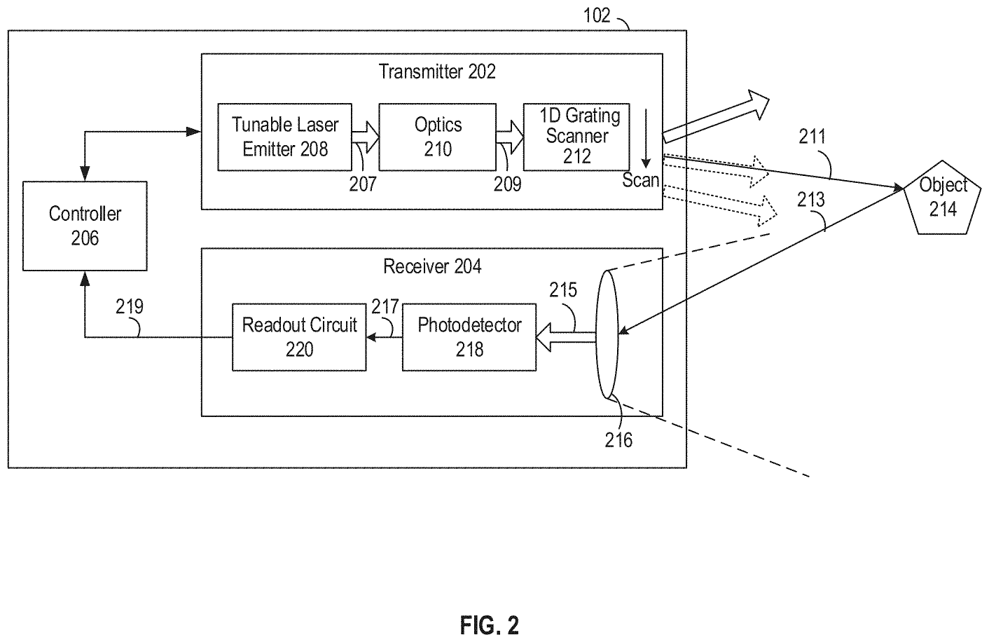

FIG. 2 illustrates a block diagram of an exemplary LiDAR system 102 containing a tunable laser emitter 208 and a 1D grating scanner 212, according to embodiments of the disclosure. In some embodiments, LiDAR system 102 may be a scanning flash LiDAR, a semi-coaxial LiDAR, a coaxial LiDAR, etc. As illustrated, LiDAR system 102 may include a transmitter 202, a receiver 204, and a controller 206 coupled to transmitter 202 and receiver 204. Transmitter 202 may further include a tunable laser emitter 208 for emitting optical signals with varying wavelengths and one or more optics 210 for collimating the optical signals with varying wavelengths. In some embodiments, transmitter 202 may additionally include a 1D grating scanner 212 for steering the collimated optical signals towards the environment. Receiver 204 may further include a receiving lens 216, a photodetector 218, and a readout circuit 220.

Transmitter 202 may emit optical beams (e.g., pulsed laser beams, continuous wave (CW) beams, frequency modulated continuous wave (FMCW) beams) along multiple directions. Transmitter 202 may include a tunable laser emitter 208, one or more optics 210, and a 1D grating scanner 212. According to one example, transmitter 202 may sequentially emit a stream of laser beams with varying wavelengths during the scanning process.

Tunable laser emitter 208 may be configured to emit laser beams 207 with varying wavelengths (also referred to as “native laser beams”) to optics 210. For instance, tunable laser emitter 208 may generate laser beams in the ultraviolet, visible, or near-infrared wavelength range, and provide the generated laser beams to optics 210. In some embodiments of the disclosure, depending on underlying laser technology used for generating laser beams, tunable laser emitter 208 may include one or more of a double heterostructure (DH) laser emitter, a quantum well laser emitter, a quantum cascade laser emitter, an interband cascade (ICL) laser emitter, a separate confinement heterostructure (SCH) laser emitter, a distributed Bragg reflector (DBR) laser emitter, a distributed feedback (DFB) laser emitter, a vertical-cavity surface-emitting laser (VCSEL) emitter, a vertical-external-cavity surface-emitting laser (VECSEL) emitter, an extern-cavity diode laser emitter, etc., or any combination thereof. Depending on the specific application, tunable laser emitter 208 may include any suitable number of laser emitting units in a package. For example, tunable laser emitter 208 may include a single emitter containing a single light-emitting unit, a multi-emitter unit containing multiple single emitters packaged in a single chip, an emitter array or laser diode bar containing multiple (e.g., 10, 20, 30, 40, 50, etc.) single emitters in a single substrate, an emitter stack containing multiple laser diode bars or emitter arrays vertically and/or horizontally built up in a single package, etc., or any combination thereof. Depending on the operating time, tunable laser emitter 208 may include one or more of a pulsed laser diode (PLD), a CW laser diode, a Quasi-CW laser diode, etc., or any combination thereof. Depending on the semiconductor materials of diodes in tunable laser emitter 208, the wavelength of incident laser beams 207 may vary, such as between 1500-1550 nm, 1400-1600 nm, 1300-1350 nm, 1300-1700 nm, or other ranges.

Optics 210 may include optical components (e.g., lenses, mirrors) that can shape the laser light and collimate the laser light into a narrow laser beam 209 to increase the scan resolution and the range to scan object(s) 214. 1D grating scanner 212 may include various optical elements such as prisms, mirrors, gratings, optical phased array (e.g., liquid crystal-controlled grating), or any combination thereof. Consistent with embodiments of the disclosure, 1D grating scanner 212 in LiDAR system 102 may include a mass platform and a grating structure on the surface of the platform. The grating structure may include a plurality of grating slits aligned on the surface of the mass platform. In some embodiments, 1D grating scanner 212 may additionally include a MEMS actuation mechanism, or another actuation mechanism, that controls 1D grating scanner 212 to rotate around a rotational axis of 1D grating scanner 212.

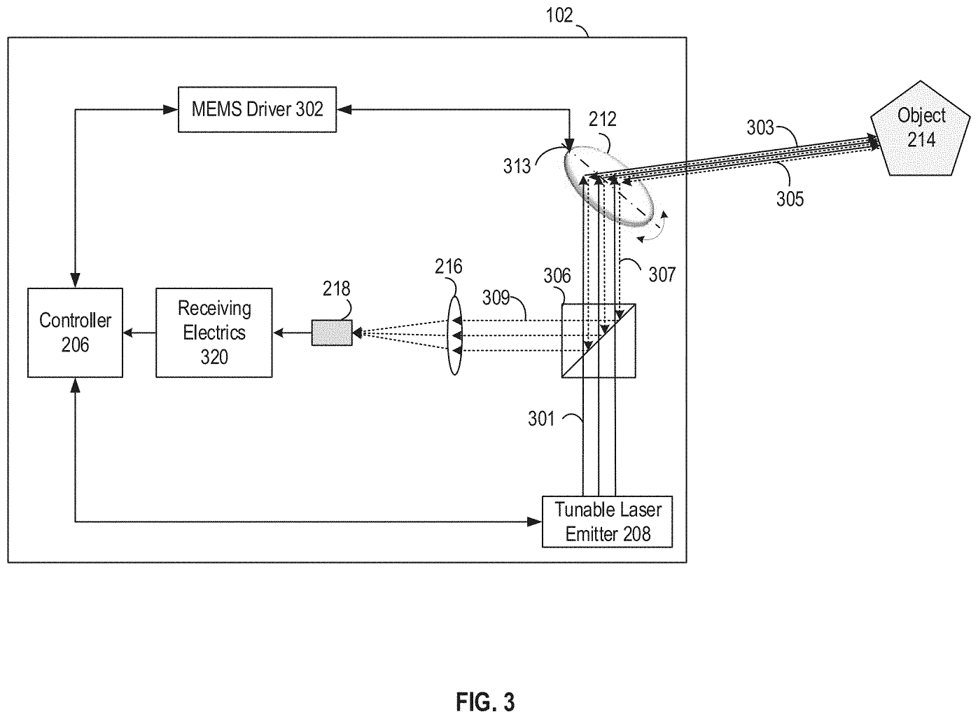

Object(s) 214 may be made of a wide range of materials including, for example, non-metallic objects, rocks, rain, chemical compounds, aerosols, clouds, and even single molecules. In some embodiments, at each time point during a scanning process, the rotating 1D grating scanner 212 may continuously direct the emitted laser beams with varying wavelengths towards objects in the environment in a 2D scanning manner, as described in more detail in connection with FIGS. 3-8.

Receiver 204 may be configured to detect returned laser beams 213 reflected by object 214. Upon contact, laser beams can be reflected/scattered by object 214 via backscattering, such as Raman scattering, and fluorescence. Returned laser beams 213 may be in a same or different direction from laser beams 211. In some embodiments, receiver 204 may collect at least a portion of laser beams returned from object 214 and output signals reflecting the intensity of the returned laser beams.

As illustrated in FIG. 2, receiver 204 may include a receiving lens 216, a photodetector 218, and a readout circuit 220. Receiving lens 216 may be configured to converge and focus a returned laser beam 213 on photodetector 218 as a focused laser beam 215.

Photodetector 218 may be configured to detect the focused laser beams 215. In some embodiments, photodetector 218 may convert a laser beam 215 into an electrical signal 217 (e.g., a current or a voltage signal). Electrical signal 217 may be an analog signal which is generated when photons are absorbed in a photodiode included in photodetector 218. In some embodiments, photodetector 218 may include a PIN detector, an avalanche photodiode (APD) detector, a single photon avalanche diode (SPAD) detector, a silicon photo multiplier (SiPM) detector, or the like. In some embodiments, photodetector 218 may include a plurality of photosensors or pixels arranged in a one-dimensional, two-dimensional, or even three-dimensional array.

Readout circuit 220 may be configured to integrate, amplify, filter, and/or multiplex signal detected by photodetector 218 and transfer the integrated, amplified, filtered, and/or multiplexed signal 219 onto an output port (e.g., controller 206) for readout. In some embodiments, readout circuit 220 may act as an interface between photodetector 218 and a signal processing unit (e.g., controller 206). Depending on the configurations, readout circuit 220 may include one or more of a transimpedance amplifier (TIA), an analog-to-digital converter (ADC), a time-to-digital converter (TDC), or the like.

Controller 206 may be configured to control transmitter 202 and/or receiver 204 to perform detection/sensing operations. For instance, controller 206 may control tunable laser emitter 208 to emit laser beams 207 with varying wavelengths. In addition, controller 206 may control 1D grating scanner 212 to rotate according to a certain pattern (e.g., certain rotation direction and rotation speed). In some embodiments, controller 206 may also implement data acquisition and analysis. For instance, controller 206 may collect digitalized signal information from readout circuit 220, determine the distance of object 214 from LiDAR system 102 according to the travel time of laser beams, and construct a high-definition map or 3D buildings and city modeling surrounding LiDAR system 102 based on the distance information of object(s) 214. In some embodiments, controller 206 may simultaneously control 1D grating scanner 212 and tunable laser emitter 208, so as to achieve a 2D scanning of the environment by LiDAR system 102, as further described in detail below in connection with FIGS. 3-8.

FIG. 3 illustrates a schematic diagram of an exemplary operation of a LiDAR system containing a tunable laser emitter and a 1D grating scanner, according to embodiments of the disclosure. As illustrated in FIG. 3, a LiDAR system 102 may include a tunable laser emitter 208, a 1D grating scanner 212, a MEMS driver 302 coupled to 1D grating scanner 212, a controller 206 coupled to the MEMS driver 302 and tunable laser emitter 208. In addition, LiDAR system 102 may further include a receiving lens 216, a photodetector 218, and receiving electronics 320. Optionally, LiDAR system 102 may further include a beam splitter 306 that separates emitted laser beams from returning laser beams.

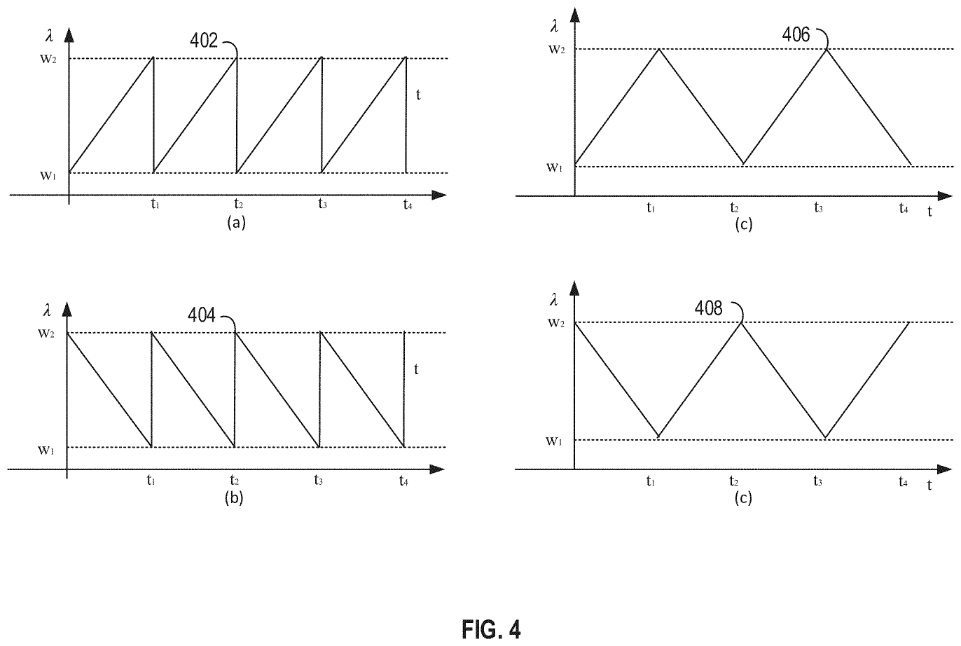

Tunable laser emitter 208 may be configured to sequentially emit a series of laser beams 301 that have varying wavelengths during a scanning process. That is, instead of emitting laser beams with a fixed wavelength, tunable laser emitter 208 may emit laser beams with a continuously varying wavelength. For instance, the wavelength of the laser beams emitted by tunable laser emitter 208 may continuously increase within a certain wavelength range, continuously decrease within a certain wavelength range, continuously increase then continuously decrease, continuously decrease then continuously increase, or may vary according to certain other patterns. FIG. 4 shows four example change patterns of the wavelength of the laser beams emitted by tunable laser emitter 208. As shown in Part (a) of FIG. 4, the wavelength of the emitted laser beams may continuously increase from w₁ to w₂ during a period of 0-t₁. After the wavelength of the laser beams reaches w₂, the wavelength of the laser beams may directly go back to w₁ at moment t₁, and repeat the cycle as shown in the figure. From Part (a) of FIG. 4, it can be seen that wavelengths of the emitted laser beams may vary within a certain range between w₁ and w₂. In addition, the slope may reflect the varying rate of the varying wavelengths of the emitted laser beams. In some embodiments, the range and the varying rate of the emitted laser beams may be predefined according to the needs, e.g., based on the target resolution and the scanning distance. In some embodiments, the range and varying rate of the emitted laser beams may dynamically change if the target resolution and the scanning distance are changed, e.g., from an urban area to a rural area.

Part (b) of FIG. 4 shows another example change of the wavelength of the laser beams emitted by tunable laser emitter 208. Compared to the change of wavelength shown in Part (a), the wavelength of the laser beams may continuously decrease from w₂ to w₁ during the period of 0-t₁. After the wavelength of the laser beams reaches w₁, the wavelength of the laser beams may directly go back to w₂ at moment t₁, and repeat the cycle as shown in the figure. Part (c) shows another example change of the wavelength of the laser beams emitted by tunable laser emitter 208. Compared to the wavelength change shown in Part (a), the wavelength of the laser beams may slowly decrease from w₂ to w₁ through the period of t₁-t₂, instead of directly going back to w₁ at moment t₁. Part (d) shows yet another example wavelength change, in which the wavelength of the emitted laser beams may continuously decrease from w₂ to w₁, then continuously increase from w₁ to w₂. It is to be noted that Parts (a)-(d) in FIG. 4 are merely some example changes of the wavelength emitted by tunable laser emitter 208. Other patterns of wavelength change of the laser beams emitted by tunable laser emitter 208 are also possible and contemplated in the present disclosure. In some embodiments, once emitted, the laser beams with varying wavelengths may pass through beam splitter 306 and reach 1D grating scanner 212, as illustrated in FIG. 3.

1D grating scanner 212 may be configured to direct the laser beams with varying wavelengths towards the environment in a 2D scanning manner. To achieve such a 2D scanning, two different mechanisms may be employed by 1D grating scanner 212. The first mechanism is implemented by the MEMS-actuated rotation of 1D grating scanner 212, while the second mechanism is implemented by the grating diffraction of the laser beams with varying wavelengths by the grating structure of 1D grating scanner 212.

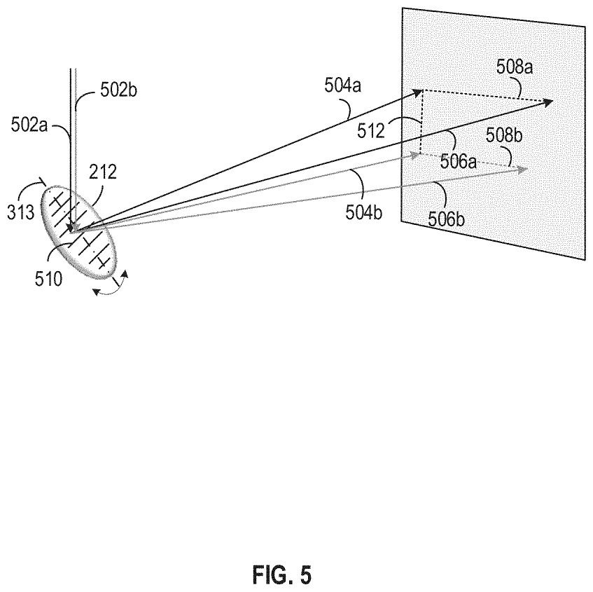

In the MEMS-actuated rotation of 1D grating scanner 212, the 1D grating scanner may be controlled to rotate around a rotational axis of the 1D grating scanner. For instance, as illustrated FIG. 3, 1D grating scanner 212 may be controlled to rotate around a rotational axis 313 of the 1D grating scanner. By rotating around rotational axis 313, 1D grating scanner 212 may direct the laser beams incident on the scanner to scan in one dimension, i.e., to achieve a first dimensional scanning of the 2D scanning. For instance, as shown in FIG. 5, at first, a series of laser beams 502a with a first wavelength may be incident on the rotating 1D grating scanner 212. The rotation of 1D grating scanner 212 may cause the series of laser beams 211 to be directed towards different directions (e.g., a series of directions between a first direction of laser beam 504a and a second direction of laser beam 506a) in a dimension indicated by a dotted line 508a. After scanning of dotted line 508a, a series of laser beams 502b with a second wavelength may be incident on the rotating 1D grating scanner 212 again. The rotation of 1D grating scanner 212 may cause the series of laser beams 502b to be directed towards different directions (e.g., a series of directions between a first direction of laser beam 504b and a second direction of laser beam 506b) in a dimension indicated by a dotted line 508b. It can be seen from the figure that the dotted line 508a and dotted line 508b are parallel to each other, and therefore in the same scanning dimension—the first dimension. That is, the rotation of 1D grating scanner 212 may cause the incident laser beams incident on 1D grating scanner 212 to scan along a first dimension indicated by 508a/508b.

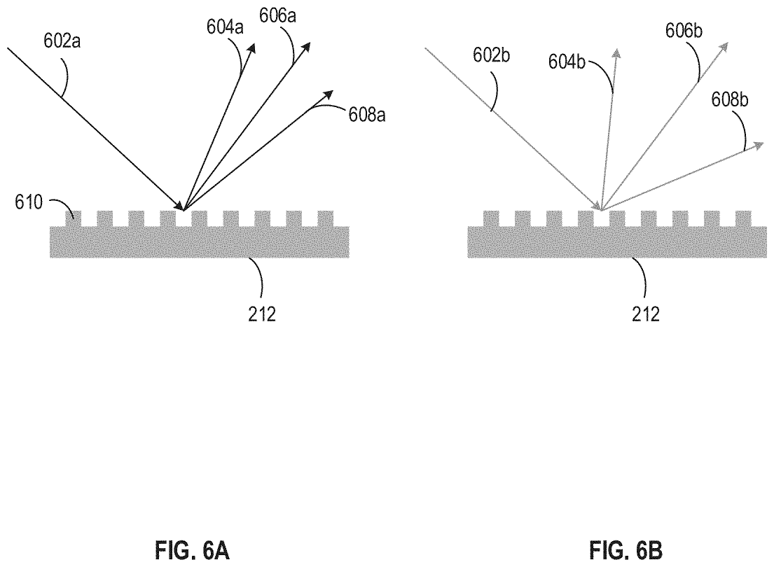

A second dimensional scanning of the 2D scanning may be achieved through grating diffraction of laser beams with varying wavelengths by 1D grating scanner 212, specifically by the grating structure on the surface of 1D grating scanner 212. To achieve such a dimensional scanning may require a specialized grating structure, e.g., a plurality of grating slits, to be integrated onto the surface of 1D grating scanner 212, where the plurality of grating slits may be disposed in a direction perpendicular to the aforementioned rotational axis 313 of 1D grating scanner 212. Arranged in this way, when the laser beams emitted by tunable laser emitter 208 are incident on 1D grating scanner 212 in a plane along or in parallel with rotational axis 313, the incident angle of the incident laser beams may remain unchanged when 1D grating scanner 212 rotates along rotational axis 313. For instance, laser beams 502a and 502b may be incident on the surface of 1D grating scanner 212 at a same incident angle with reference to a grating vector direction (e.g., a direction aligned with rotational axis 313) when 1D grating scanner 212 rotates along rotational axis 313. As a result, the second dimensional scanning of the 2D scanning may be achieved without rotating 1D grating scanner in the second dimension. That is, the second dimensional scanning may be achieved by the disclosed LiDAR system 102 with less moving or mechanical parts required when compared to other existing 2D scanning LiDAR systems. To achieve the second-dimensional scanning without requiring the motion of 1D grating scanner 212, the underlying scanning mechanism lies on the grating diffraction by the grating structure on the surface of 1D grating scanner 212 in combination with the varying wavelengths of the laser beams emitted by tunable laser emitter 208, as further described in detail below with reference to FIGS. 6A-6B.

FIGS. 6A-6B illustrate example grating diffraction of laser beams with different wavelengths. In FIGS. 6A-6B, a laser beam 602a/602b is incident on the surface of the 1D grating scanner 212 in a direction perpendicular to a plurality of grating slits 610. The grating diffraction of laser beam 602/602b by grating slits 610 may split and diffract the incident laser beam 602a/602b into several beams traveling in different directions, as illustrated in the figures. The directions or the angles of these laser beams may depend on the wavelength of the incident laser beam and properties, such as spacing, depth, and so on, of grating slits 610. For instance, with certain properties of grating slits 610, the incident laser beam 602a/602b may be split into three laser beams 604a/604b, 606a/606b, and 608a/608b, as illustrated in FIGS. 6A-6B. Among the three split laser beams, 604a/604b, 606a/606a, and 608a/608b may be specifically the −1^{st} order, 0^{th} order, and 1^{st} order diffraction laser beams, among which the directions of the −1^{st} order laser beam 604a/604a and the 1^{st} order laser beam 608a/608b may be dependent on the wavelength of the incident laser beam 602a/602b. For instance, laser beams 602a and 602b may have different wavelengths, which causes the split laser beams 604a and 604b (similarly for 608a and 608b) to travel in different directions, as shown in FIGS. 6A-6B. In some embodiments, the shorter the wavelength of the incident laser beam, the closer the −1^{st} order split laser beam to the incident laser beam. For instance, in FIGS. 6A-6B, laser beam 602b may have a shorter wavelength than laser beam 602a, and thus the split −1^{st} order laser beam 604b is closer to incident laser beam 602b than the split −1^{st} order laser beam 604a to 602a. Accordingly, by changing the wavelength of incident laser beams, the split −1^{st} order laser beams of these incident laser beams may be directed towards different directions, thereby achieving the second-dimensional scanning. Another exemplary illustration of the second-dimensional scanning may be found in FIG. 5, in which incident laser beams 502a and 502b may have different wavelengths, and thus the split −1^{st} order laser beams 504a and 504b are directed towards different directions, to achieve the second dimension of scanning, as indicated by a dotted line 512.

It is to be noted that, in the foregoing description of the second dimensional scanning, while three laser beams 604a/604b, 606a/606b, and 608a/608b are split from the incident laser beam 602a/602b, by properly configuring 1D grating scanner 212, specifically the grating structure of 1D grating scanner 212, the majority of the laser power may be carried by one of the three laser beams 604a/604b, 606a/606b, and 608a/608b. For instance, by proper configuration, over 95% of the laser power of an incident laser beam may be carried by the −1^{st} order laser beam 604a/604b. The properties of 1D grating scanner 212 that can be configured may include a configuration of a spacing between grating slits, a width of each grating slit, a depth of each grating slit, and a material used to make each grating slit, etc. With the majority of the laser power of the incident laser beam 602a/602b in the −1^{st} order laser beam 604a/604b, the range covered by different −1^{st} laser beams may be then considered as the scanning coverage of 1D grating scanner 212 in the second dimension. It is also to be noted that, while only three split laser beams are illustrated in FIGS. 6A-6B, in real applications, there may be more than three orders of laser beams split and diffracted from the incident laser beam. However, through proper configuration, the laser power of the incident laser beam may still be carried by mainly one order of the split laser beam, which may then serve as the laser source for scanning the environment and thus be used to define the scanning coverage of the second-dimensional scanning.

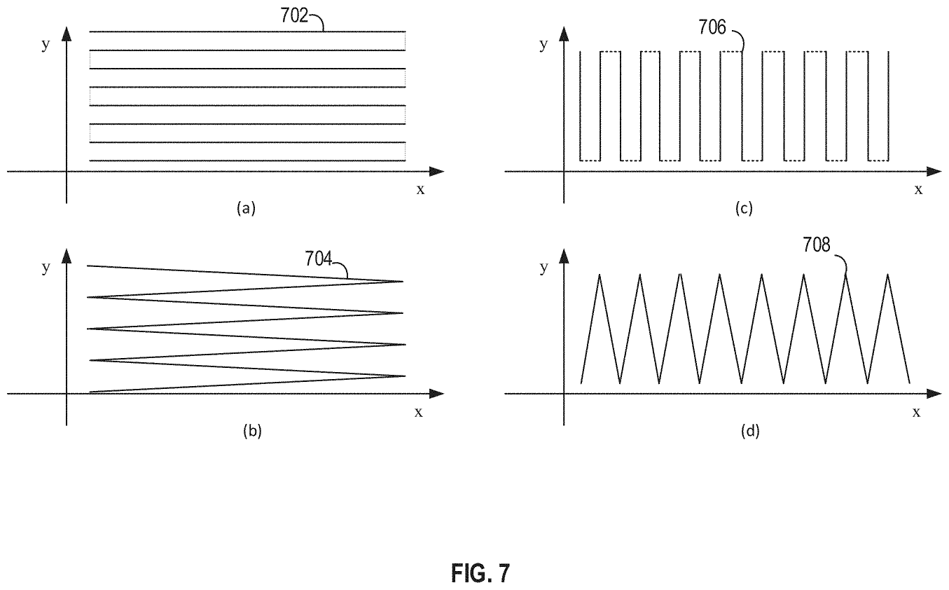

In the two-dimensional scanning achieved by the 1D grating scanner 212, there may be two scanning trajectories, one known as the slow trajectory and the other the fast trajectory. During a scanning process, one scanning trajectory may be accomplished by controlling the wavelength changing rate of the incident laser beams (e.g., wavelength changing rate of laser beams 301 emitted by tunable laser emitter 208 shown in FIG. 3), while the other scanning trajectory may be accomplished by controlling the rotation speed of 1D grating scanner 212 around the rotational axis. By controlling the wavelength changing rate at a predefined rate (e.g., a fixed changing rate or a varying changing rate) and the rotation speed at a predefined speed (e.g., a fixed rotation speed or a varying rotation speed), different scanning patterns may be achieved, as further illustrated in detail in FIG. 7.

Parts (a)-(d) of FIG. 7 illustrate various exemplary scanning patterns that may be achieved by the disclosed LiDAR system 102, in which the x-axis may represent the first dimension (e.g., the dimension accomplished by rotating 1D grating scanner 212) while the y axis may represent the second dimension (e.g., the dimension accomplished by changing the wavelength of the incident laser beams) of the 2D scanning achieved by the disclosed LiDAR system. Specifically, in Parts (a) and (b), the first dimension, or the dimension accomplished by rotating 1D grating scanner 212, may be the fast trajectory, while the second dimension, or the dimension accomplished by changing the wavelength of laser beams, may be the slow trajectory. The difference between Parts (a) and (b) may be caused by the difference in the wavelength changing patterns of the emitter laser beams (or the incident laser beams). In Part (a), the wavelength of the emitted laser beams only changes after each rotation cycle when 1D grating scanner 212 rotates, but does not change within each rotation cycle (e.g., a forward rotation may be considered as one cycle and a backward rotation may be considered as another cycle). However, in Part (b), the wavelength of the emitted laser beams also changes within each rotation cycle, although at a relatively slower rate, that is, a longer time is required to complete one wavelength changing cycle when compared to the time required to complete one rotation cycle.

Parts (c) and (d) show two other scanning patterns that may be achieved by the disclosed LiDAR system 102. In the two scanning patterns, the fast trajectory may be accomplished by changing the wavelength of the incident laser beams (e.g., laser beams 301 emitted by tunable laser emitter 208 shown in FIG. 3) while the slow trajectory may be accomplished by the rotation of 1D grating scanner 212 around rotational axis 313. In the scanning pattern shown in Part (c), 1D grating scanner 212 may not rotate within one cycle of wavelength change, but rotate to a different position after each cycle of wavelength change. In the scanning part shown in Part (d), both the wavelength change and the rotation around the rotational axis may occur simultaneously, but the wavelength of the incident laser beams changes faster than the rotation of 1D grating scanner 212. That is, a longer time is required to complete one rotation cycle when compared to the time required to complete one wavelength changing cycle.

It is to be noted that the four scanning patterns shown in FIG. 7 are merely some example scanning patterns that can be accomplished through controlling the rotation speed of 1D grating scanner 212 and the wavelength change of laser beams emitted by tunable laser emitter 208. Other scanning patterns are also possible and are contemplated by the present disclosure.

Referring back to FIG. 3, as illustrated in the figure, a LiDAR system 102 may further include a controller 206 configured to control the rotation speed of 1D grating scanner 212 and the wavelength change of laser beams emitted by tunable laser emitter 208, so as to achieve a specific 2D scanning pattern. For instance, controller 206 may control tunable laser emitter 208 to emit laser beams within a certain wavelength range, and control the wavelength change of laser beams emitted by tunable laser emitter 208. For another instance, controller 206 may control the rotation of 1D grating scanner 212, for example, through a MEMS driver 302 as illustrated in FIG. 3.

MEMS driver 302 may include any digital input or analog input MEMS driver that drives 1D grating scanner 212 to rotate within certain rotation angles. For that purpose, 1D grating scanner 212 may include a MEMS-actuated platform that is controllable by MEMS driver 302, to drive the grating structure, including the plurality of grating slits of 1D grating scanner 212, to rotate around rotational axis 313. For instance, the MEMS-actuated platform may be a comb drive actuated platform. It is to be noted that while the MEMS driver 302 is illustrated to drive the rotation of 1D grating scanner 212, in some embodiments, other different actuation mechanisms may be employed to drive the rotation of the grating structure of 1D grating scanner 212. These other actuation mechanisms may include electro-thermal, piezo-electric, and electro-magnetic actuation mechanisms, and the like. These different actuation mechanisms, when controlled by controller 206, may drive 1D grating scanner 212 to rotate according to a certain pattern, such as when to rotate, at what rotation speed, at what rotation direction, when to stop, etc. In some embodiments, controller 206 is further configured to control a rotation speed of the 1D grating scanner according to a target resolution for the 2D environmental sensing. In some embodiments, controller 206 may simultaneously control MEMS driver 302 and tunable laser emitter 208 to work cooperatively, so as to produce various two-dimensional scanning patterns (e.g., scanning patterns illustrated in FIG. 7).

It is to be noted that, while controller 206 is illustrated as a single unit, in some embodiments, controller 206 may include two or more controllers 206. For instance, controller 206 may include a first controller for controlling MEMS driver 302 and a different second controller for controlling tunable laser emitter 208. The first and second controllers may communicate with each other, or both communicate with a different third controller, so as to exchange information to allow MEMS driver 302 and tunable laser emitter 208 to work cooperatively to produce different scanning patterns. In some embodiments, controller 206 may itself implement or may additionally include a separate controller for implementing data processing and data analysis, e.g., constructing a high-definition map or 3D buildings and city modeling based on the signals detected by photodetector 218.

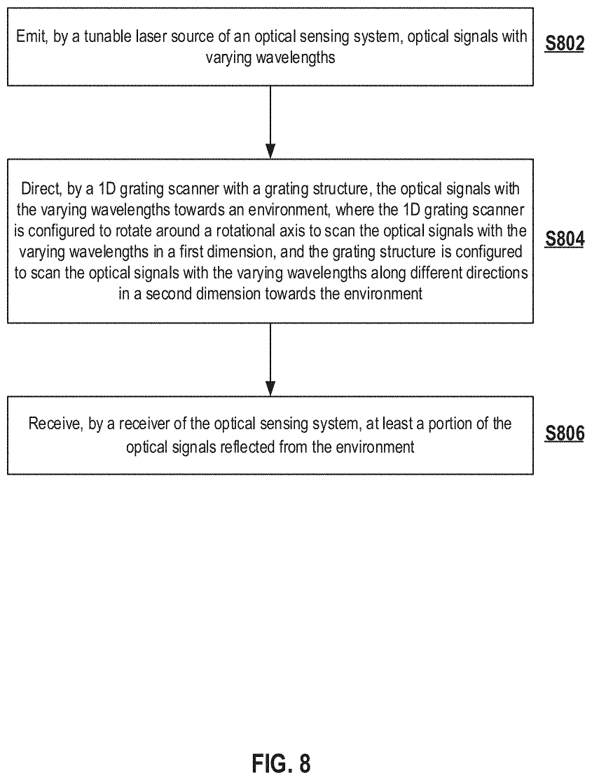

As also illustrated in FIG. 3, a LiDAR system 102 may further include a beam splitter 306 to separate returning laser beams (e.g., laser beams reflected by object 214) from the laser beams emitted by tunable laser emitter 208, one or more receiving lens 216 for converging and focusing the retuning laser beams transmitted by beam splitter 306, a photodetector 218 for detecting the returning laser beams, and receiving electronics 320 for further processing the detected signals. Other possible components included in a LiDAR system 102 but not illustrated in FIG. 3 may include, but are not limited to, one or more optics for collimating laser beams emitted by tunable laser emitter 208. These components and other components described earlier with reference to FIG. 3 may together allow LiDAR system 102 to achieve a two-dimensional scanning in environment sensing. Specific detail about environmental sensing using the disclosed LiDAR system 102 will be described further below in connection with FIG. 8.

FIG. 8 is a flow chart of an exemplary optical sensing method 800 performed by a LiDAR system containing a tunable laser emitter and a 1D grating scanner, according to embodiments of the disclosure. In some embodiments, method 800 may be performed by various components of LiDAR system 102, e.g., transmitter 202 containing a tunable laser emitter 208 and a 1D grating scanner 212, receiver 204, and/or controller 206. In some embodiments, method 800 may include steps S802-S806. It is to be appreciated that some of the steps may be optional. Further, some of the steps may be performed simultaneously, or in a different order than that shown in FIG. 8.

In step S802, a tunable laser source (e.g., tunable laser emitter 208) inside a transmitter of an optical sensing system (e.g., transmitter 202 of LiDAR system 102) may emit a series of optical signals. Here, the series of emitted optical signals may be emitted by the optical source at a predefined time interval. In addition, the series of signals may have varying wavelengths during a period when the optical sensing system is sensing an environment surrounding the system. The wavelength of the emitted laser beams may vary according to a predefined pattern e.g., consistently increase and/or decrease within a certain wavelength range. A controller (e.g., controller 206) may control the optical source to emit laser beams with the wavelength varying following the predefined pattern. The emitted laser beams may be collimated (e.g., by optics 210) and then incident on a 1D grating scanner (e.g., 1D grating scanner 212). For instance, as shown in FIG. 3, controller 206 may control tunable laser emitter 208 to emit a series of laser beams 301 with varying wavelengths, which then are incident on 1D grating scanner 212 after collimation by the one or more optics (not shown in FIG. 3).

In step S804, the 1D grating scanner may direct the emitted laser beams with varying wavelengths towards different directions of the environment following a two-dimensional scanning pattern. The first dimension of the 2D scanning may be achieved by rotating the 1D grating scanner around a rotational axis of the 1D grating scanner. Different mechanisms, such as MEMS, electro-thermal, piezo-electric, and electro-magnetic actuation mechanisms, and the like, may be employed to drive the rotation of the 1D grating scanner around the rotational axis. The second dimension of the 2D scanning may be achieved by the grating diffraction of the laser beams with varying wavelengths by the grating structure on the surface of the 1D grating scanner. For instance, as shown in FIG. 3, the rotating 1D grating scanner may direct the series of laser beams 303 towards the environment (e.g., towards object 214) in the aforementioned two-dimensional scanning manner.

In step S806, a receiver of the optical sensing system may receive at least a portion of the optical signals reflected from the environment. For instance, as shown in FIG. 3, when the series of laser beams 303 reach object 214, object 214 may reflect the laser beams back. Among the reflected laser beams, at least a portion (e.g., laser beams 305) may reach the rotating 1D grating scanner, which then reflects the laser beams (e.g., laser beams 307) towards beam splitter 306. Beam splitter 306 may then transmit the laser beams (e.g., laser beams 309) towards receiving lens 216, which further focuses the laser beams on photodetector 218. Photodetector 218 may detect the focused laser beams as analog or digital signals, which are then further processed in the receiving electronics 320 and controller 206, so that a high-definition map or 3D buildings and city modeling may be constructed based on the detected signals.

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An optical sensing system for two-dimensional (2D) environmental sensing, comprising:
a tunable laser source, configured to emit optical signals with varying wavelengths;
a one-dimensional (1D) grating scanner, configured to rotate around a rotational axis to scan the optical signals with the varying wavelengths in a first dimension towards an environment surrounding the optical sensing system, wherein the 1D grating scanner comprises a grating structure configured to scan the optical signals with the varying wavelengths along different directions in a second dimension towards the environment at each rotation angle; and
a receiver, configured to receive at least a portion of the optical signals with the varying wavelengths reflected from the environment.

2. The optical sensing system of claim 1, wherein the optical signals emitted by the tunable laser source have wavelengths varying at a predefined rate.

3. The optical sensing system of claim 1, wherein the optical signals emitted by the tunable laser source have wavelengths varying at a varying rate, wherein the optical sensing system further comprises a controller configured to control the varying rate.

4. The optical sensing system of claim 1, wherein the optical signals emitted by the tunable laser source have varying wavelengths within a predefined wavelength range.

5. The optical sensing system of claim 1, wherein the 1D grating scanner comprises a mass platform and the grating structure comprises at least one diffraction grating patterned on the mass platform.

6. The optical sensing system of claim 5, wherein the at least one diffraction grating patterned on the mass platform comprises a set of grating slits on the mass platform.

7. The optical sensing system of claim 6, wherein the rotational axis is perpendicular to the set of grating slits.

8. The optical sensing system of claim 1, wherein each of the emitted optical signals with the varying wavelengths is incident on the 1D grating scanner at a same incident angle with reference to a grating vector direction.

9. The optical sensing system of claim 1, wherein each of the emitted optical signals with the varying wavelengths is incident on the 1D grating scanner within a plane along or in parallel with the rotational axis.

10. The optical sensing system of claim 1, further comprising a controller configured to control a rotation speed of the 1D grating scanner according to a target resolution for the 2D environmental sensing.

11. The optical sensing system of claim 1, further comprising a controller configured to implement signal processing and data analysis based on the at least a portion of the optical signals with the varying wavelengths reflected from the environment.

12. An optical sensing method for an optical sensing system, comprising:
emitting, by a tunable laser source of the optical sensing system, optical signals with varying wavelengths;
directing, by a 1D grating scanner of the optical sensing system, the optical signals with the varying wavelengths towards an environment surrounding the optical sensing system, wherein the 1D grating scanner is configured to rotate around a rotational axis to scan the optical signals with the varying wavelengths in a first dimension towards the environment, wherein the 1D grating scanner comprises a grating structure configured to scan the optical signals with the varying wavelengths along different directions in a second dimension towards the environment at each rotation angle; and
receiving, by a receiver of the optical sensing system, at least a portion of the optical signals with the varying wavelengths reflected from the environment.

13. The optical sensing method of claim 12, wherein emitting the optical signals with varying wavelengths comprises:
emitting the optical signals with the wavelengths varying at a varying rate, wherein the optical sensing system further comprises a controller configured to control the varying rate.

14. The optical sensing method of claim 12, wherein emitting the optical signals with varying wavelengths comprises:
emitting the optical signals with the varying wavelengths within a predefined wavelength range.

15. The optical sensing method of claim 12, wherein emitting the optical signals with varying wavelengths comprises:
emitting the optical signals with the varying wavelengths towards the 1D grating scanner at a same incident angle on the 1D grating scanner with reference to a grating vector direction.

16. The optical sensing method of claim 12, wherein emitting the optical signals with varying wavelengths comprises:
emitting the optical signals with the varying wavelengths towards the 1D grating scanner, wherein the emitted optical signals with the varying wavelengths are incident on the 1D grating scanner within a plane along or in parallel with the rotational axis.

17. A transmitter for an optical sensing system, comprising:
a tunable laser source, configured to emit optical signals with varying wavelengths;
one or more optics, configured to collimate the optical signals with the varying wavelengths; and
a one-dimensional (1D) grating scanner, configured to rotate around a rotational axis to scan the optical signals with the varying wavelengths in a first dimension towards an environment surrounding the optical sensing system, wherein the 1D grating scanner comprises a grating structure configured to scan the optical signals with the varying wavelengths along different directions in a second dimension towards the environment at each rotation angle.

18. The transmitter of claim 17, wherein the 1D grating scanner comprises a mass platform and the grating structure comprises at least one diffraction grating patterned on the mass platform.

19. The transmitter of claim 18, wherein the at least one diffraction grating patterned on the mass platform comprises a set of grating slits on the mass platform.

20. The transmitter of claim 19, wherein the rotational axis is perpendicular to the set of grating slits.
